(19) United States
(12) Patent Application Publication
(10) Pub. No.: US 2011/0305140 A1
(43) Pub. Date: Dec. 15, 2011

(54) WIRELESS COMMUNICATION RESOURCE ASSIGNING APPARATUS, BASE STATION APPARATUS AND WIRELESS RESOURCE ASSIGNING METHOD

(76) Inventors: Xiaoqiu WANG, Fujimino-shi (JP); Satoshi KONISHI, Fujimino-shi (JP)

(21) Appl. No.: 13/156,628

(22) Filed: Jun. 9, 2011

(30) Foreign Application Priority Data
Jun. 10, 2010 (JP) 2010-133197

(51) Int. Cl. H04W 24/02; H04W 24/08; H04W 72/04

(52) U.S. Cl. 370/232; 370/329; 370/253

(57) ABSTRACT

A wireless resource assignment method includes: a step of, from terminals that issue requests for assigning wireless resources, selecting a predetermined number of said terminals that are candidates to which the wireless resources are assigned in accordance with evaluation indices of at lease one of an application layer and a TCP layer of said terminals arranged in descending order; and a step of assigning the wireless resources to the predetermined number of said selected terminals that are wireless resource assignment candidate terminals while maximizing the evaluation indices of a physical layer.

### BACKGROUND OF THE INVENTION

1. Field of the Invention

Priority is claimed on Japanese Patent Application No. 2010-133197, filed Jun. 10, 2010, the content of which is incorporated herein by reference.

The present invention relates to a wireless communication resource assigning apparatus, a base station apparatus and a wireless resource assigning method.

2. Description of Related Art

In a wireless communication system, in accordance with a technique of Orthogonally Frequency Division Multiplex Access (OFDMA) or a technique of Signal Carrier Frequency Division Multiplexing Access (SC-FDMA), it is possible to have Multi-user Diversity gain by assigning a frequency band with high quality to each user (so called frequency scheduling technique), and thereby improve the frequency spectrum usage efficiency.

A wireless communication system has a tradeoff between system quality (in general, the cell-throughput of a physical layer is used as an evaluation index) and fairness between multiple terminals (in general, the average throughput of a terminal at a cell-edge regarding a physical layer is used as an evaluation index). A packet scheduler (PF scheduler) is known which uses a PF (proportional fairness) method as a scheduling method which balances such system quality and fairness between terminals. Regarding the PF scheduler a PF evaluation index is predefined as the ratio between an instant data rate and the average data rate, a frequency resource is assigned to terminals so as to maximize the PF evaluation index. When the PF scheduler is applied to a communication operation conducted by an application program based on TCP (transmission control protocol), in general, an assignment operation of wireless resources is conducted in accordance with the best-effort policy regardless of a service quality provided by the application program.

Patent Document proposes a multilayer optimizing scheduling technique which is based on a multi-objective function and which is used for improving the service quality of the application program based on TCP. In the prior art described in Patent Document 1, an evaluation index on each layer (application layer, TCP layer and physical layer) is calculated, and an index value (assignment index) used for assigning a wireless resource is calculated based on the multi-objective function. After this, according to the assignment index arranged in a descending order when larger is better, one of the terminals is selected to which the wireless resource is assigned, and an assignment operation of the wireless resource is conducted. Such an operation is repeatedly conducted until the end of the wireless resource that can be assigned or until the end of the terminals that are candidates to which the wireless resource is assigned.

### [Patent Document 1]

Japanese Patent Application, First Publication No. 2009-224836

However, the above-described prior art, that is, Patent Document 1 has a problem as described below.

(Problem 1) The assignment index includes evaluation indices applied to upper layers (application layer and TCP layer) and a physical layer. However, the evaluation indices applied to the upper layers have a long cycle of fluctuation, and on the other hand, the physical layer has a short cycle of fluctuation. Therefore, the evaluation index of the physical layer fluctuates during the time between updates of the evaluation indices of the upper layers, and as a result, fluctuation of the assignment index depends on fluctuation of the evaluation index of the physical layer. As a result, there is a possibility in which the evaluation indices of the high layers are not reflected in the assignment index, and there is difficulty in improving the service quality of the application program based on TCP.
(Problem 2) There is difficulty to have a desired Multi-user Diversity gain when using OFDMA or SC-FDMA because each terminal is selected in accordance with the assignment index arranged in a descending order and to which the wireless resource is assigned.

The present invention is conceived in consideration of such a background and has an object to provide a wireless resource assigning apparatus, a base station apparatus and a wireless resource assigning method that reliably reflect the evaluation index of the application layer or the TCP layer to the assignment of the wireless resource and that reduces difficulty in having a desired Multi-user Diversity gain when using OFDMA or SC-FDMA.

### SUMMARY OF THE INVENTION

The present invention includes aspects explained below. However, it should be noted that the aspects explained below do not limit the present invention.

A first aspect is a wireless resource assignment apparatus for assigning a wireless resource to terminals when the terminals communicate with a base station in a wireless system, including: a wireless resource assignment candidate terminal selection portion which, from the terminals that issue requests for assigning the wireless resource, selects a predetermined number of said terminals that are candidates to which wireless resources are assigned in accordance with evaluation indices of at lease one of an application layer and a TCP layer regarding said terminals arranged in descending order; and a wireless resource assignment portion which assigns the wireless resources to the predetermined number of said selected terminals that are wireless resource assignment candidate terminals while maximizing the evaluation indices regarding a physical layer.

A second aspect is the above-described wireless resource assignment apparatus, wherein if un-assigned wireless resources still remains after assigning the wireless resources to the predetermined number of said selected wireless resource assignment candidate terminals, the wireless resource assignment portion assigns the un-assigned wireless resources to the terminals which issue the wireless resource assignment requests other than the wireless resource assignment candidate terminals selected by the wireless resource assignment candidate terminal selection portion while maximizing the evaluation indices regarding the physical layer.

A third aspect is the wireless resource assignment apparatus described above, further including a TCP average throughput calculation portion which calculates a TCP instant throughput every when time the base station receives TCP-ACK from the terminals and calculates the TCP average throughput by using the TCP instant throughput, wherein the wireless resource assignment candidate terminal selection portion uses the TCP average throughput as the evaluation indices of the TCP layer, and the wireless resource assignment apparatus assigns the wireless resources applied to downlinks to the terminals.

A fourth aspect is the above-described wireless resource assignment apparatus, further including a TCP/IP packet counting portion which counts the number of TCP/IP packets that are received by the base station for a predetermined time and that are directed to the terminals, wherein the wireless resource assignment candidate terminal selection portion uses the number of the TCP/IP packets as the evaluation indices of the TCP layer, and the wireless resource assignment apparatus assigns the wireless resources applied to downlinks to the terminals.

A fifth aspect is the above-described wireless resource assignment apparatus, further including a TCP average throughput calculation portion which calculates a TCP instant throughput every when time the base station transmits TCP-ACK the terminals and calculates the TCP average throughput by using the TCP instant throughput, wherein the wireless resource assignment candidate terminal selection portion uses the TCP average throughput as the evaluation indices of the TCP layer, and the wireless resource assignment apparatus assigns the wireless resources applied to uplinks to the terminals.

A sixth aspect is the above-described wireless resource assignment apparatus, further including an information collection portion which collects information of a TCP average throughput from the terminals that is calculated every time the terminals receive TCP-ACK, wherein the wireless resource assignment candidate terminal selection portion uses the TCP average throughput as the evaluation indices of the TCP layer, and the wireless resource assignment apparatus assigns the wireless resources applied to uplinks to the terminals.

A seventh aspect is the wireless resource assignment apparatus, further including an information collection portion which collects information of a congestion window (cwnd) size from the terminals of the TCP layer, wherein the wireless resource assignment candidate terminal selection portion uses the cwnd size as the evaluation indices of the TCP layer, and the wireless resource assignment apparatus assigns the wireless resources applied to uplinks to the terminals.

An eighth aspect is the above-described wireless resource assignment apparatus, further including an information collection portion which collects information of a number of TCP/IP packets received by the terminals from the terminals, wherein the wireless resource assignment candidate terminal selection portion uses the number of the TCP/IP packets as the evaluation indices of the TCP layer, and the wireless resource assignment apparatus assigns the wireless resources applied to downlinks to the terminals.

A ninth aspect is the above-described wireless resource assignment apparatus, further including: an information collection portion which collects information of receiving time of TCP/IP packets received by the terminals from the terminals; and a TCP/IP packet counting portion which counts the number of TCP/IP packets received by the terminals for a predetermined time based on the collected information, wherein the wireless resource assignment candidate terminal selection portion uses the number of the TCP/IP packets as the evaluation indices of the TCP layer, and the wireless resource assignment apparatus assigns the wireless resources applied to downlinks to the terminals.

A tenth aspect is a wireless communication system including one of the above-described wireless resource assignment apparatuses.

An eleventh aspect is a wireless resource assignment method for assigning wireless resources to terminals that is used when the terminals communicate with a base station in a wireless system, including: a first step of, from the terminals that issue requests for assigning the wireless resources, selecting a predetermined number of said terminals that are candidates to which the wireless resources are assigned in accordance with evaluation indices of at lease one of an application layer and a TCP layer corresponding to said terminals arranged in descending order; and a second step of assigning the wireless resources to the predetermined number of said selected terminals that are wireless resource assignment candidate terminals so as to maximize the evaluation indices of a physical layer.

A twelfth aspect is the above-described wireless resource assignment method according to Claim 11, further including a third step of, if un-assigned wireless resources still remain after assigning the wireless resources to the predetermined number of said selected wireless resource assignment candidate terminals, assigning the un-assigned wireless resources to the terminals which issue the wireless resource assignment requests other than the wireless resource assignment candidate terminals selected by the first step so as to maximize the evaluation indices of the physical layer.

In accordance with the present invention, it is possible to have an advantage in which the evaluation index of the application layer or the TCP layer is reliably reflected to the assignment of the wireless resources and in which the difficulty of having a desired Multi-user Diversity gain when using OFDMA or SC-FDMA is reduced.

### BRIEF DESCRIPTION OF THE DRAWINGS

FIG. 1A shows an outline concept (of a prior art) for explaining an outline of one embodiment of the present invention.

FIG. 1B shows an outline concept (of the present invention) for explaining an outline of one embodiment of the present invention.

FIG. 2 is an outline block diagram of a base station of a wireless communication system of one embodiment of the present invention.

FIG. 3 is a flowchart of a wireless resource assignment operation shown in FIG. 1 conducted by a resource assignment portion.

FIG. 4 shows an example of a downlink transmission/reception sequence of TCP/IP packets for explaining a TCP instant throughput of one example of the present invention.

FIG. 5 is a flowchart showing details of Step 2 of FIG. 3 for one example of the present invention.

FIG. 6 is a flowchart showing details of Step S4 of FIG. 3 for one example of the present invention.

FIG. 7 shows an example of an uplink transmission/reception sequence of TCP/IP packets showing a TCP instant throughput of another example of the present invention.

FIG. 8 shows an example of a downlink transmission/reception sequence of TCP/IP packets showing the TCP instant throughput of another example of the present invention.

FIG. 9 is a flowchart showing details of Step 2 of FIG. 3 for another example of the present invention.

FIG. 10 is a flowchart showing details of Step 4 of FIG. 3 for another example of the present invention.

### DETAILED DESCRIPTION OF THE INVENTION

Hereinafter, embodiments of the present invention are explained in reference to the drawings.

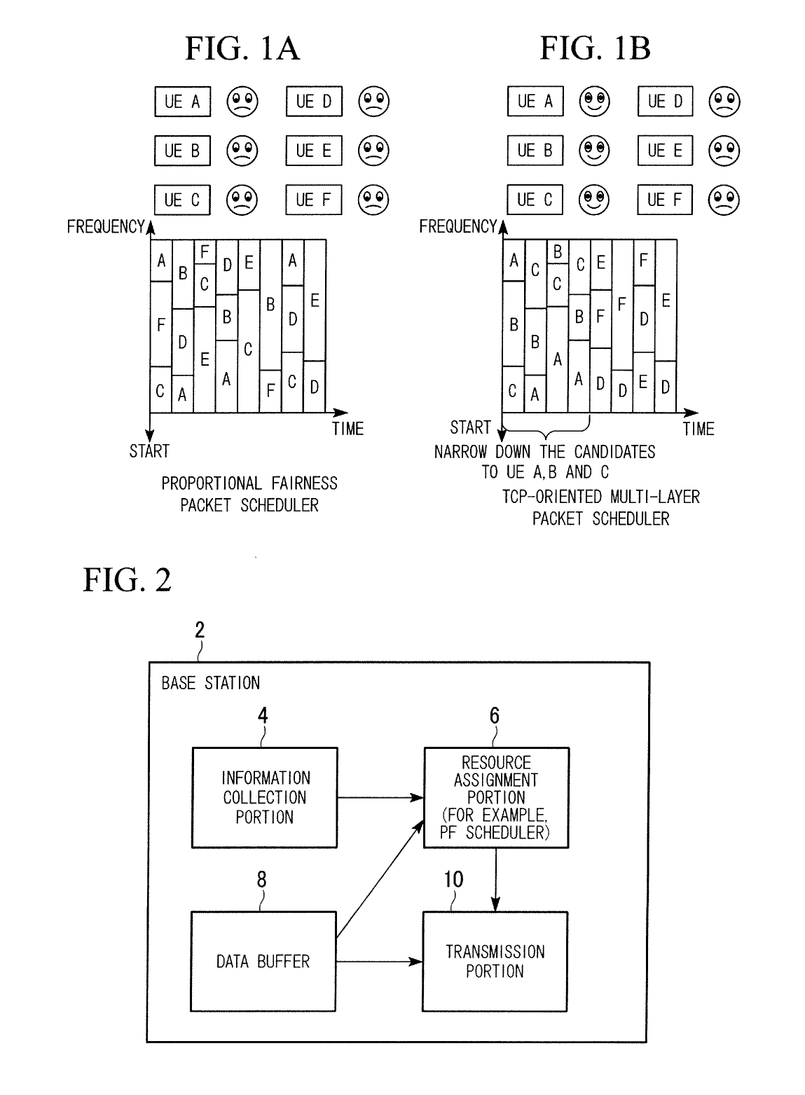

First, the outline of the present invention is explained in reference to FIGS. 1A and 1B. FIGS. 1A and 1B are drawings outlining concepts of the embodiments, FIG. 1A outlines a concept of a PF scheduler of a prior art, and FIG. 1B outlines a concept of a packet scheduler (TCP-oriented multi-layer packet scheduler) of the embodiments below.

Various information is supposed which indicates the service quality with respect to an application program based on TCP (hereinafter, application program). For example, time (hereinafter, total receiving time) required for downloading contents (for example, a Web page and a movie file) from a server by a terminal is information that indicates service quality for the application program.

A conventional PF scheduler shown in FIG. 1A assigns wireless resources to terminals UE_A . . . UE_F based on the PF evaluation index of the physical layer. In such a case, a data rate on the physical layer of each of the terminals UE_A . . . UE_F is respectively different. However, the total receiving time of the application program is substantially the same between the terminals UE_A . . . UE_F. Therefore, there is a possibility in which users of the terminals UE_A . . . UE_F may be equally and poorly satisfied with the service quality with respect to the application programs.

On the other hand, from the terminals which issue requests for assigning the wireless resources, a packet scheduler of one embodiment shown in FIG. 1B selects a predetermined number of candidate terminals to which the wireless resources are assigned in accordance with the evaluation index with regard to an application layer or a TCP layer arranged in descending order, and after this, the packet scheduler assigns the wireless resources to the predetermined number of selected terminals so as to maximize the evaluation index with regard to the physical layer. In an example shown in FIG. 1B, the packet scheduler selects three terminals UE_A, UE_B and UE_C from six terminals UE_A . . . UE_F in accordance with the evaluation index with regard to an application layer or a TCP layer arranged in descending order and assigns the wireless resources to these three terminals UE_A, UE_B and UE_C so as to maximize the evaluation index with regard to the physical layer. Due to such an operation, it is possible to reduce or improve the total receiving time of the application programs executed on the terminals UE_A, UE_B and UE_C which have comparatively preferable evaluation indices with regard to the application layer or the TCP layer, and it is possible to have a desirable Multi-user Diversity gain. As a result, it is possible to achieve improved efficiency of the wireless resources, and a user of each of the terminals UE_A, UE_B and UE_C can be further satisfied with the service quality with regard to the application programs.

FIG. 2 is an outline block diagram of a base station 2 of the wireless communication system of this embodiment. FIG. 2 describes a constitution of a wireless resource assigning apparatus. In FIG. 2, an information collection portion 4 collects information used for assigning the wireless resources. A resource assignment portion 6 assigns the wireless resources to the terminals. A data buffer 8 temporally stores packets based on TCP and IP (Internet protocol) directed to a terminal received via an IP network. A transmission portion 10 conducts a wireless transmission of data to the terminals.

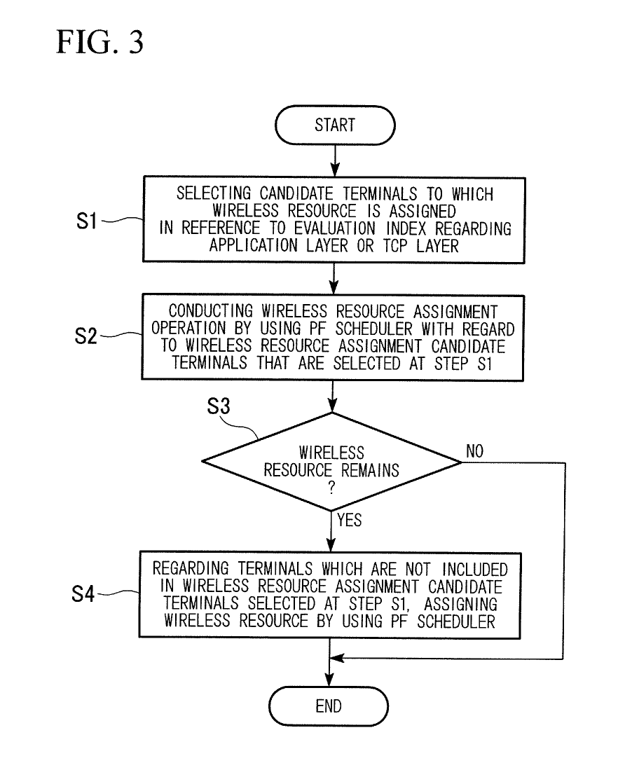

FIG. 3 is a flowchart of a wireless resource assigning operation shown in FIG. 1 conducted by a resource assignment portion 6. In reference to FIG. 3, a wireless resource assignment operation of this embodiment is explained.

### (Step S1)

The candidate terminals to which the wireless resources are assigned are selected in reference to the evaluation index of the application layer or the TCP layer. Here, from the terminals which issue the wireless resource assignment requests, a predetermined number (N) of terminals are selected in accordance with the evaluation index with regard to the application layer or the TCP layer arranged in descending order. Therefore, it is possible to surely reflect the evaluation index with regard to the application layer or the TCP layer to the wireless resource assignment operation. It should be noted that it is possible to specify the number of terminals (N) that are selected as wireless resource assignment candidate terminals by using a predetermined parameter.

### (Step S2)

A wireless resource assignment operation is conducted by using a PF scheduler with regard to the wireless resource assignment candidate terminals that are selected in Step S1. Here, the PF scheduler assigns the wireless resources to the wireless resource assignment candidate terminals so as to maximize the evaluation index with regard to the physical layer. Due to such an operation, based on the evaluation index with regard to the application layer or the TCP layer, it is possible to achieve both fairness between the terminals and the Multi-user Diversity gain with regard to the selected wireless resource assignment candidate terminals.

### (Step S3)

The resource assignment portion 6 determines whether or not the wireless resources that can be assigned still remains (un-assigned wireless resources) based on a result of assigning the wireless resources in Step S2. Based on such a determination result, the resource assignment portion 6 conducts an operation of Step S4 if there are un-assigned wireless resources (“YES” in Step S3), and the resource assignment portion 6 returns from the operation shown in FIG. 3 if there are not the un-assigned wireless resources (“NO” in Step S3).

### (Step S4)

Regarding the terminals which issue the wireless resource assignment requests and which are not included in the wireless resource assignment candidate terminals selected in Step S1, the resource assignment portion 6 assigns the un-assigned wireless resources by using the PF scheduler so as to maximize the evaluation index with regard to the physical layer.

Hereinafter, a wireless resource assignment operation shown in FIG. 3 conducted by the base station 2 is explained by showing examples.

### Example 1

Example 1 shows an example of assigning the wireless resources of a downlink (in a direction from a base station to terminals) to the terminals in a wireless communication system conforms to LTE (long term evolution). OFDMA is used in the downlink of the LTE system. It should be noted that an example of assigning the wireless resources is explained using RBG (resource block group) to simplify explanations. Hereinafter, with respect to each step shown in FIG. 3, Example 1 is explained in detail.

### [Step S1]

In Step S1, from the terminals which issue the wireless resource assignment requests, a predetermined number (N) of the candidate terminals to which the wireless resources are assigned are selected in reference to the evaluation index of the application layer or the TCP layer. It is possible to use two types of the evaluation indices (A-1) and (A-2) shown below as the evaluation index with regard to the application layer.

### (A-1) Data Rate of Application Program

A data rate of an application program is, for example, notified by a contents server from which a terminal downloads the contents. The terminals are selected as candidates for assigning the wireless resources in accordance with the data rate of the application programs arranged in descending order.

### (A-2) Priority of Application Program

Regarding priority of an application program, for example, in a case in which a type of the application program (for example, ftp, video streaming and http) is notified by a contents server from which a terminal downloads the contents, the priority of the application program is predetermined in correspondence to the type of the application program, and the priority corresponding to the type of the application program notified by a contents server is used. The candidate terminals to which the wireless resources are assigned are selected in accordance with the priority of the application programs arranged in descending order.

It is possible to use following two evaluation indices (B-1) and (B-2) as the evaluation indices of the TCP layer.
(B-1): An Estimate of a “Congestion Window Size (Hereinafter, cwnd Size)” of the TCP Layer

The cwnd size is estimated because it is not easy to have the accurate cwnd size from the contents server in general. There is a relationship shown in a following equation between the cwnd size and a number of TCP/IP packets which are stored in the data buffer 8 of the base station 2 in a predetermined time and are directed to a terminal (hereinafter, number of TCP/IP packets received in a predetermined time). “cwnd size”=“number of TCP/IP packets received in a predetermined time”+“number of TCP/IP packets directed to resident terminals in the network”

In this Example 1, the number of TCP/IP packets received in a predetermined time is the estimate of the cwind size. The wireless resource assignment candidate terminals are selected in accordance with the estimate of the cqind size (number of TCP/IP packets received in a predetermined time) arranged in descending order.

The data buffer 8 counts the number of TCP/IP packets received in a predetermined time with regard to each direction of the TCP/IP packets and notifies the number of TCP/IP packets received in a predetermined time for each terminal to the resource assignment portion 6.

### (B-2): Average Throughput of TCP Layer (Hereinafter, TCP Average Throughput)

A TCP average throughput is defined by using instant throughputs of the TCP layer (hereinafter, TCP instant throughput) as shown in the below formula.

E(n)=(1−α)×E(n−1)+α×X(n)

It should be noted that E(n) is a TCP average throughput updated in an n-th updating operation, X(n) is a TCP instant throughput which is updated in an n-th updating operation, and α is a forgetting factor.

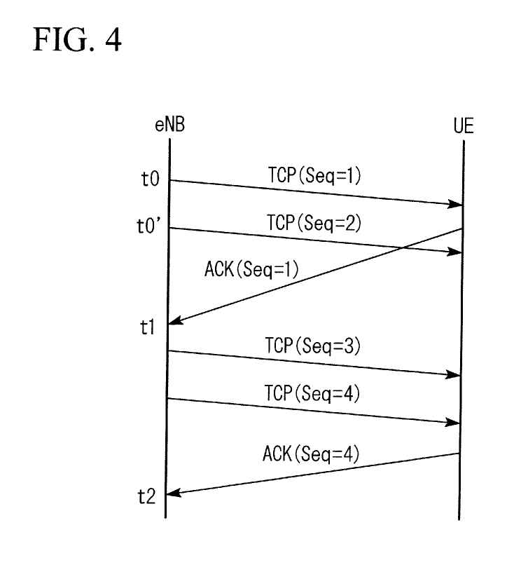

The wireless resource assignment candidate terminals are selected in accordance with the TCP average throughput arranged in descending order. The TCP instant throughput is defined in a following manner. FIG. 4 shows an example of a downlink transmission/reception sequence of TCP/IP packets for explaining the TCP instant throughput. In FIG. 4, when the base station 2 (eNB) receives a TCP-ACK from the terminal (UE), the TCP instant throughput is calculated. Every time the base station 2 receives the TCP-ACK from the terminals, the resource assignment portion 6 calculates the TCP instant throughput and calculates the TCP average throughput to update the TCP average throughput by using the calculated TCP instant throughput.

When an ACK bit is on included in the header information of the TCP/IP packet received by the base station 2 from the terminal (when the received TCP/IP packet is TCP-ACK), the resource assignment portion 6 reads and memorizes sequence information included in the header information and calculates the TCP instant throughput. Hereinafter, a calculation method of the TCP instant throughput is explained.

When “sequence number included in TCP-ACK received this time”>“sequence number included in previously received TCP-ACK”, the TCP instant throughput is calculated in accordance with the following equation.

TCP instant throughput=A/B

It should be noted that A is a sum of a size of each TCI/IP packet between “a sequence number included in the previously received TCP-ACK” and “a sequence number included in the TCP-ACK received this time”. B is “a receiving time of the TCP-ACK received this time”—“a transmission time or a received time by the data buffer 8 of a TCP/IP packet corresponding to the latest number between the sequence number of the previously received TCP-ACK and the sequence number of the TCP-ACK received this time”.

For example, in FIG. 4, “TCP instant throughput X(1) at time t1=(size of TCP/IP packet (sequence number=1))/(t1−t0)”. In addition, “TCP instant throughput X(2) at time t2=(size of TCP/IP packets (sequence numbers=2, 3 an 4))/(t2−t0′)”.

On the other hand, when “sequence number included in TCP-ACK received this time”<=“sequence number included in previously received TCP-ACK”, the TCP instant throughput is calculated in accordance with the following equation.

TCP instant throughput=0

In this Example 1, by using the evaluation indices of the application layer (data rate or priority of the application program) or the evaluation indices of the TCP layer (estimate of cwnd size or TCP average throughput), the resource assignment portion 6 selects a predetermined number (N) of the candidate terminals to which the wireless resources are assigned in reference to the evaluation indices arranged in descending order.

It should be noted that when there is a terminal which has multiple TCP connections concurrently being established, the evaluation index is calculated by using quality of the TCP layer of the multiple TCP connections. It is possible to apply the maximum value, minimum value, average value, sum and/or median of the TCP quality to such an evaluation index.

In addition, when the maximum number (M) of terminals that can be assigned to one subframe is limited due to a limitation of the wireless resources of a control channel used for notifying a result of assigning the wireless resources to the terminals and/or due to a limitation of performance of a processor which conducts assignment of the wireless resources, a condition “N<=M” should be satisfied.

### [Step S2]

In Step S2, only to the candidate terminals for assigning the wireless resources selected in Step S1 (wireless resource assignment candidate terminals), the PF scheduler assigns the wireless resources (RBG) so as to maximize the evaluation index of the physical layer (hereinafter, PF evaluation index). The PF evaluation index is defined as a ratio between a instant data rate and an average data rate, and the PF scheduler assigns RBG to the terminals so as to maximize the PF index. Here, “the number of wireless resource assignment candidate terminals (N)<=the maximum number of the terminals for assignment (M)” is satisfied, and it is not necessary to operate or manage the number of the terminals to which RBG is assigned so as to be equal to or less than M.

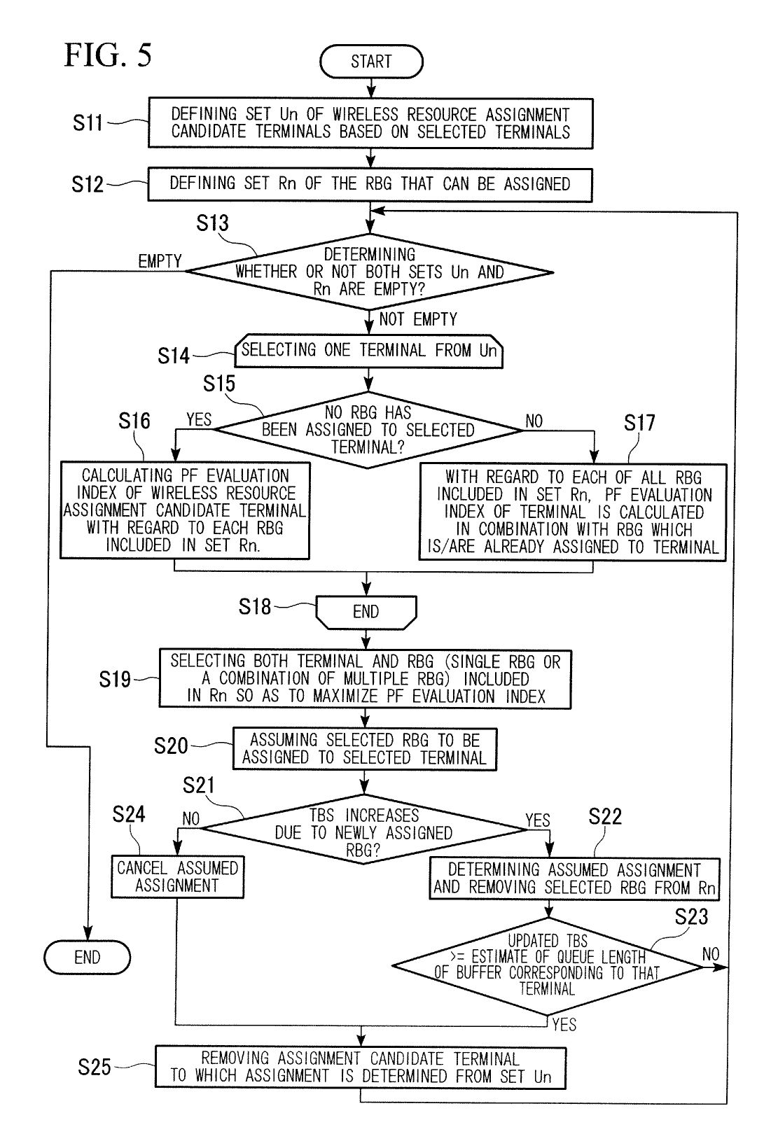

FIG. 5 is a flowchart showing details of Step 2 of FIG. 3 for Example 1. FIG. 5 shows an RBG assignment operation of Step S2 conducted on one subframe. Hereinafter, in reference to FIG. 5, details of Step 2 of FIG. 3 for Example 1 are explained.

### (Step S11)

A set Un of the wireless resource assignment candidate terminals is defined based on all wireless resource assignment candidate terminals selected in Step S1

### (Step S12)

A set Rn of the RBG that can be assigned is defined based on all RBG that can be assigned.

### (Step S13)

A determination operation is conducted to determine whether or not the set Un which is a set of the wireless resource assignment candidate terminals is empty and whether or not the set Rn which is a set of the RBG that can be assigned is empty. Base on such determination results, if both the sets Un and Rn are not empty, an operation of Step S14 is conducted, and if at least one of the sets Un and Rn is not empty, operations of FIG. 5 are finished.

In Steps S14-S18, the PF evaluation index of each of all wireless resource assignment candidate terminals included in the set Un is calculated respectively with regard to all RBG of the set Rn that can be assigned.

### (Step S14)

One of the wireless resource assignment candidate terminals is selected from the set Un.

### (Step S15)

A determination operation is conducted to determine whether or not the RBG is assigned to the wireless resource assignment candidate terminal selected in Step S14. Based on such a determination result, if no RBG is assigned to the wireless resource assignment candidate terminal, an operation of Step S16 is conducted, and if at least one RBG is assigned to the wireless resource assignment candidate terminal, an operation of Step S17 is conducted.

### (Step S16)

The PF evaluation index of the wireless resource assignment candidate terminals to which no RBG is assigned yet is calculated respectively with regard to all RBG of the set Rn that can be assigned.

### (Step S17)

With regard to all RBG of the set Rn that can be assigned, the PF evaluation index of the wireless resource assignment candidate terminals is calculated to which at least one RBG is assigned in combination with RBG which is/are already assigned.

### (Step S18)

An operation of Step S19 is conducted when calculation of the PF evaluation indices is finished with regard to all wireless resource assignment candidate terminals of the set Un.

### (Step S19)

The maximum PF evaluation index is selected from the PF evaluation indices calculated in Steps S14-S18, and both the wireless resource assignment candidate terminal and RBG (single RBG or a combination of multiple RBG, hereinafter, assignment candidate RBG) are selected corresponding to the selection result of the maximum PF evaluation index.

### (Step S20)

The wireless resource assignment candidate terminal and assignment candidate RBG selected in Step S19 are memorized as wireless resource assignment temporal information.

### (Step S21)

A determination operation is conducted to determine whether or not the maximum data size for transportation (transport block size: TBS) of the wireless resource assignment candidate terminal selected in Step S19 is increased due to the assignment candidate RBG. Based on the determination result, an operation of Step S22 is conducted if TBS increases, and an operation of Step S24 is conducted if TBS does not increase.

### (Step S22)

If TBS of the wireless resource assignment candidate terminal increases due to the assignment candidate RBG, the wireless resource assignment temporal information memorized in Step S20 is determined as wireless resource assignment information, and the assignment candidate RBG is removed from the set Rn which is a set of RBG that can be assigned.

### (Step S23)

A determination operation is conducted to determine whether or not “TBS (updated TBS) increased due to the assignment candidate RBG”>=“data size stored in the data buffer 8 directed to the wireless resource assignment candidate terminal (estimate of a queue length)” is satisfied. If such an equation is true, an operation of Step S25 is conducted. On the other hand, if such an equation is not true, an operation of Step S13 is conducted while the wireless resource assignment candidate terminal is still included in the set Un.

### (Step S24)

If TBS of the wireless resource assignment candidate terminal does not increase due to the assignment candidate RBG, the wireless resource assignment temporal information memorized in Step S20 is cancelled.

### (Step S25)

When the wireless resource assignment temporal information is cancelled, or when the equation of Step S23 is true, the wireless resource assignment candidate terminal is removed from the set Un. After this, an operation of Step S13 is conducted.

### [Step S3]

In Step S3, a determination operation is conducted to determine whether or not RBG that can be assigned (un-assigned RBG) remains after assigning the wireless resources in Step S2. As a result of such a determination, if the un-assigned RBG still remains, an operation of Step S4 is conducted, and if the un-assigned RBG does not remain, operations of FIG. 3 are finished. However, if “the number of wireless resource assignment candidate terminals (N)=the maximum number of the terminals for assignment (M)” is satisfied, the operations of FIG. 3 are finished regardless of whether or not the un-assigned RBG remains. Therefore, only if the un-assigned RBG remains and “N<M”, an operation of Step S4 is conducted.

### [Step S4]

In Step S4, to the terminals which issue the wireless resource assignment requests other than the terminals that are the wireless resource assignment candidate terminals selected in Step S1, the PF scheduler assigns the un-assigned RBG so as to maximize the evaluation index of the physical layer. Here, RBG can be assigned to “M-N” terminals at the most. Therefore, RBG is assigned to the terminals one-by-one.

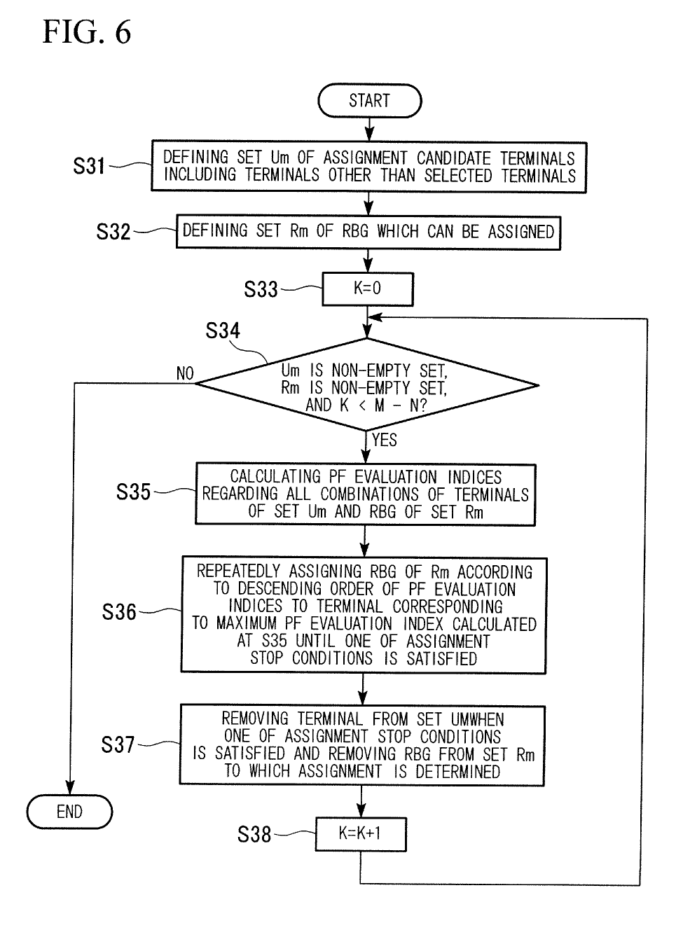

FIG. 6 is a flowchart showing details of Step S4 of FIG. 3 for Example 1. FIG. 6 shows an RBG assignment operation of Step S4 conducted on one subframe. Hereinafter, in reference to FIG. 6, details of Step S4 of FIG. 3 for Example 1 are described.

### (Step S31)

A set Um of the wireless resource assignment candidate terminals is defined based on all terminals which issue the wireless resource assignment requests other than the wireless resource assignment candidate terminals selected in Step S1

### (Step S32)

A set Rm of the RBG that have not been assigned is defined based on all RBG that are not assigned.

### (Step S33)

A number of terminals K (number of assigned terminals) is initialized by setting “0” that indicates the number of terminals assigned to one RBG to which currently no terminals are assigned.

### (Step S34)

It is determined whether or not “the set Um of the wireless resource assignment candidate terminals is not an empty set”, “the set Rm of un-assigned RBG is not an empty set” and “K<‘M-N’” are satisfied. An operation of Step S35 is conducted if such a determination result is true, and operations of FIG. 6 are finished if such a determination result is not true.

### (Step S35)

Regarding all combinations of the wireless resource assignment candidate terminals of the set Um and the un-assigned RBG of the set Rm, the PF evaluation indices are calculated.

### (Step S36)

The maximum PF evaluation index is selected from the PF evaluation indices calculated in Step S35, and both the wireless resource assignment candidate terminal and RBG (single RBG, hereinafter, assignment candidate RBG) are selected corresponding to the selection result of the maximum PF evaluation index. After this, to the combination of the selected wireless resource assignment candidate terminal and assignment candidate RBG, until at least one of following assignment stop conditions 1 and 2 is satisfied, the un-assigned RBG of the set Rm is added one-by-one in accordance with the PF evaluation indices of the un-assigned RBG arranged in descending order, and in accordance with such an operation, the RBG becomes a candidate RBG for being assigned to the wireless resource assignment candidate terminal.

Assignment stop condition 1: regarding the wireless resource assignment candidate terminal, the updated TBS which is updated by adding the un-assigned RBG is larger than a data size (estimated length of a queue) stored in the data buffer 8 directed to the wireless resource assignment candidate terminal. When the assignment condition 1 is satisfied, up to the currently added RBG, the un-assigned RBG that have been added are determined as the RBG to be assigned to the wireless resource assignment candidate terminal, and an assignment operation of the un-assigned RBG to the wireless resource assignment candidate terminal is finished.

Assignment stop condition 2: regarding the wireless resource assignment candidate terminal, the TBS updated by adding the un-assigned RBG decreases compared to the TBS before update. When the assignment condition 2 is satisfied, the currently added RBG is cancelled, the un-assigned RBG that have been added are determined as the RBG to be assigned to the wireless resource assignment candidate terminal, and an assignment operation of the un-assigned RBG to the wireless resource assignment candidate terminal is finished.

### (Step S37)

The wireless resource assignment candidate terminal to which assignment of the un-assigned RBG is completed in Step S36 is removed from the set Um of the wireless resource assignment candidate terminals, and the corresponding assigned RBG are removed form the set Rm of the un-assigned RBG.

### (Step S38)

The number of assigned terminals K is incremented by 1. After this, an operation of Step S34 is conducted.

Explanations of Example 1 are finished.

### Example 2

In Example 2, in a LTE system, the wireless resources of an uplink (directed to a base station from a terminal) are assigned to the terminal. SC-FDMA is applied to the uplink of the LTE system. SC-FDMA has a limitation in which the resource blocks (RB) that are already assigned should be successive because it is necessary to reduce PAPR (Peak to Average Power Ratio). Hereinafter, Example 2 regarding each step of FIG. 3 is explained.

### [Step S1]

In Step S1, from the terminals which issue the wireless resource assignment requests, a predetermined number (N) of the candidate terminals to which the wireless resources are assigned are selected with reference to the evaluation index of the application layer or the TCP layer. It is possible to use two types of evaluation indices (C-1) and (C-2) shown below as the evaluation index with regard to the application layer.

### (C-1) Data Rate of Application Program

A terminal uses a data rate of an application program. The information collection portion 4 collects information regarding the data rate of the application programs from the terminals. The terminals are selected as candidates for assigning the wireless resources in accordance with the data rate of the application programs arranged in descending order.

### (C-2) Priority of Application Program

A terminal uses priority of application program. A type of the application program (for example, ftp, video streaming and http) is notified by a terminal to the information collection portion 4, and the information collection portion 4 uses the priority of the application program which is predetermined in correspondence to the type of application program The candidate terminals to which the wireless resources are assigned are selected in accordance with the priority of the application programs arranged in descending order.

It is possible to use following two evaluation indices (D-1) and (D-2) as the evaluation indices of the TCP layer.

(B-1): A cwnd Size of the TCP Layer

Following (D-1-1) and (D-1-2) are two methods for obtaining the cwnd size of the TCP layer.

### (D-1-1)

The terminal transmits the cwnd size information to the base station 2. For example, a report of the cwnd size of a MAC layer that is periodically transmitted to the base station 2 is provided. The information collection portion 4 of the base station 2 collects the information including the cwnd size transmitted from the terminal.

### (D-1-2)

The terminal transmits a size and received time of TCP/IP packets received by the terminal to the base station 2. The information collection portion 4 of the base station 2 receives the size and received time of the TCP/IP packets from the terminal and estimates the number of TCP/IP packets that have been stored in the receiving data buffer of the terminal for a predetermined time based on the received information. The estimate of the number of TCP/IP packets is used as the cwnd size and is used as an evaluation value with regard to the TCP layer. It should be noted that there is a following relationship shown in a following equation between the number of TCP/IP packets that have been stored in the receiving data buffer of the terminal for a predetermined time and cwnd size.

“cwnd” size=“number of TCP/IP packets that have been stored in the receiving data buffer of the terminal for a predetermined time”+“number of TCP/IP packets directed to resident terminals in the network”

The terminals are selected as candidates for assigning the wireless resources in accordance with the cwnd size of the TCP layer or the estimate of the cwnd size arranged in descending order.

### (D-2) Average Throughput at the TCP Layer (TCP Average Throughput)

Following (D-2-1) and (D-2-2) are two methods for collecting the TCP average throughput.

### (D-2-1)

The terminals calculate the average TCP throughput by using a TCP instant throughput and transmit the information of the average TCP throughput to the base station 2. The information collection portion 4 of the base station 2 collects the information of the average TCP throughput transmitted from the terminal.

The average TCP throughput is calculated by using the TCP instant throughput in accordance with the following equation.

E(n)=(1−α)×E(n−1)+α×X(n)

Here, E(n) is a TCP average throughput which is updated in a n-th updating operation, and X(n) is a TCP instant throughput which is updated in a n-th updating operation. “α” is a forgetting factor.

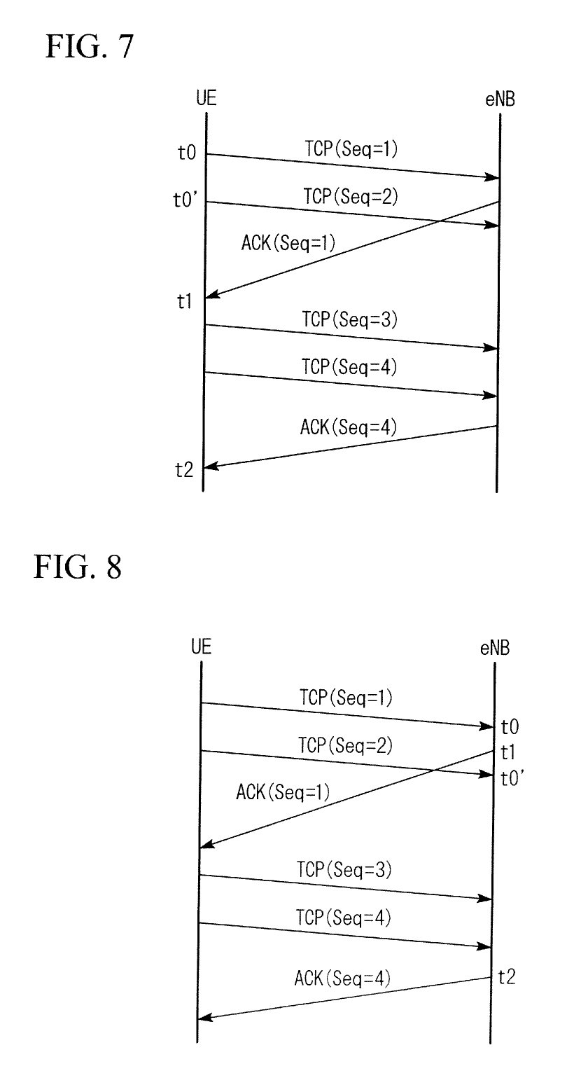

The wireless resource assignment candidate terminals are selected in accordance with the TCP average throughput arranged in descending order. The TCP instant throughput is defined in a following manner. FIG. 7 shows an example of an uplink transmission/reception sequence of TCP/IP packets for explaining a TCP instant throughput. In FIG. 7, when the terminal (UE) receives a TCP-ACK from the contents server, the TCP instant throughput is calculated. Every time the terminal (UE) receives the TCP-ACK from the contents server, the terminal calculates the TCP instant throughput and calculates the TCP average throughput to update the TCP average throughput by using the calculated TCP instant throughput.

When an ACK bit included in the header information of the received TCP/IP packet (when the received TCP/IP packet is TCP-ACK) is on, the terminal (UE) reads and memorizes sequence information included in the header information and calculates the TCP instant throughput. Hereinafter, a calculation method of the TCP instant throughput is explained.

When “sequence number included in TCP-ACK received this time”>“sequence number included in previously received TCP-ACK”, the TCP instant throughput is calculated in accordance with the following equation.

TCP instant throughput=A/B

It should be noted that A is a sum of a size of each TCI/IP packet between “a sequence number included in the previously received TCP-ACK” and “a sequence number included in the TCP-ACK received this time”. B is “a receiving time of the TCP-ACK received this time”—“a transmission time or a received time by the terminal of a TCP/IP packet corresponding to the latest number between the sequence number of the previously received TCP-ACK and the sequence number of the TCP-ACK received this time”.

For example, in FIG. 7, “TCP instant throughput X(1) at time t1=(size of TCP/IP packet (sequence number=1))/(t1−t0)”. In addition, “TCP instant throughput X(2) at time t2=(size of TCP/IP packets (sequence numbers=2, 3 an 4))/(t2−t0′)”.

On the other hand, when “sequence number included in TCP-ACK received this time”<=“sequence number included in previously received TCP-ACK”, the TCP instant throughput is calculated in accordance with the following equation.

TCP instant throughput=0

### (D-2-2)

The resource assignment portion 6 of the base station 2 calculates the average TCP throughput by using a TCP instant throughput. The average TCP throughput is calculated by using the TCP instant throughput in accordance with the following equation.

E(n)=(1−α)×E(n−1)+α×X(n)

Here, E(n) is a TCP average throughput which is updated in a n-th updating operation, and X(n) is a TCP instant throughput which is updated in a n-th updating operation. “a” is a forgetting factor.

The wireless resource assignment candidate terminals are selected in accordance with the TCP average throughput arranged in descending order. The TCP instant throughput is defined in the following manner. FIG. 8 shows an example of an uplink transmission/reception sequence of TCP/IP packets for explaining a TCP instant throughput. In FIG. 8, when the base station 2 (eNB) transmits a TCP-ACK, the TCP instant throughput is calculated. Every time the base station 2 (eNB) transmits the TCP-ACK to the terminal (UE), the base station 2 calculates the TCP instant throughput and calculates the TCP average throughput to update the TCP average throughput by using the calculated TCP instant throughput.

When an ACK bit is on included in the header information of the TCP/IP packet which is going to be transmitted to the terminal form the base station 2 (when the received TCP/IP packet is TCP-ACK), the resource assignment portion 6 of that base station 2 reads and memorizes sequence information included in the header information and calculates the TCP instant throughput. Hereinafter, a calculation method of the TCP instant throughput is explained.

When “sequence number included in TCP-ACK which is going to be transmitted this time”>“sequence number included in previously transmitted TCP-ACK”, the TCP instant throughput is calculated in accordance with the following equation.

TCP instant throughput=A/B

It should be noted that A is a sum of a size of each TCI/IP packet between “a sequence number included in the previously transmitted TCP-ACK” and “a sequence number included in the TCP-ACK which is going to be transmitted this time”. B is “a transmission time of the TCP-ACK which is going to be transmitted this time”—“a reception time from the terminal of a TCP/IP packet corresponding to the latest number between the sequence number of the previously transmitted TCP-ACK and the sequence number of the TCP-ACK which is going to be transmitted this time”.

For example, in FIG. 8, “TCP instant throughput X(1) at time t1=(size of TCP/IP packet (sequence number=1))/(t1−t0)”. In addition, “TCP instant throughput X(2) at time t2=(size of TCP/IP packets (sequence numbers=2, 3 an 4))/(t2−t0′)”.

On the other hand, when “sequence number included in TCP-ACK which is going to be transmitted this time”<=“sequence number included in previously transmitted TCP-ACK”, the TCP instant throughput is calculated in accordance with the following equation.

TCP instant throughput=0

In this Example 2, by using the evaluation indices of the application layer (data rate or priority of the application program) or the evaluation indices of the TCP layer (cwnd size, estimate of cwnd size or TCP average throughput), the resource assignment portion 6 selects a predetermined number (N) of the candidate terminals to which the wireless resources are assigned in reference to the evaluation indices arranged in descending order.

It should be noted that when there is a terminal which has multiple TCP connections concurrently being established, the evaluation index is calculated by using quality of the TCP layer of the multiple TCP connections. Such an evaluation index can be the maximum value, the minimum value, the average value, the sum and/or the median of the TCP quality.

In addition, when the maximum number (M) of terminals that can be assigned to one subframe is limited due to a limitation of the wireless resources of a control channel used for notifying the result of assigning the wireless resources to the terminals and/or due to a limitation of performance of a processor which conducts assignment of the wireless resources, a condition “N<=M” should be satisfied.

### [Step S2]

In Step S2, only to the candidate terminals for assigning the wireless resources selected in Step S1 (wireless resource assignment candidate terminals), the PF scheduler assigns the wireless resources (RB) so as to maximize the evaluation index of the physical layer (PF evaluation index). The PF evaluation index is defined as the ratio between an instant data rate and an average data rate, and the PF scheduler assigns RB to the terminals so as to maximize the PF index. Here, “the number of wireless resource assignment candidate terminals (N)<=the maximum number of the terminals for assignment (M)” is satisfied, and it is not necessary to operate or manage the number of terminals to which RB is assigned so as to be equal to or less than M.

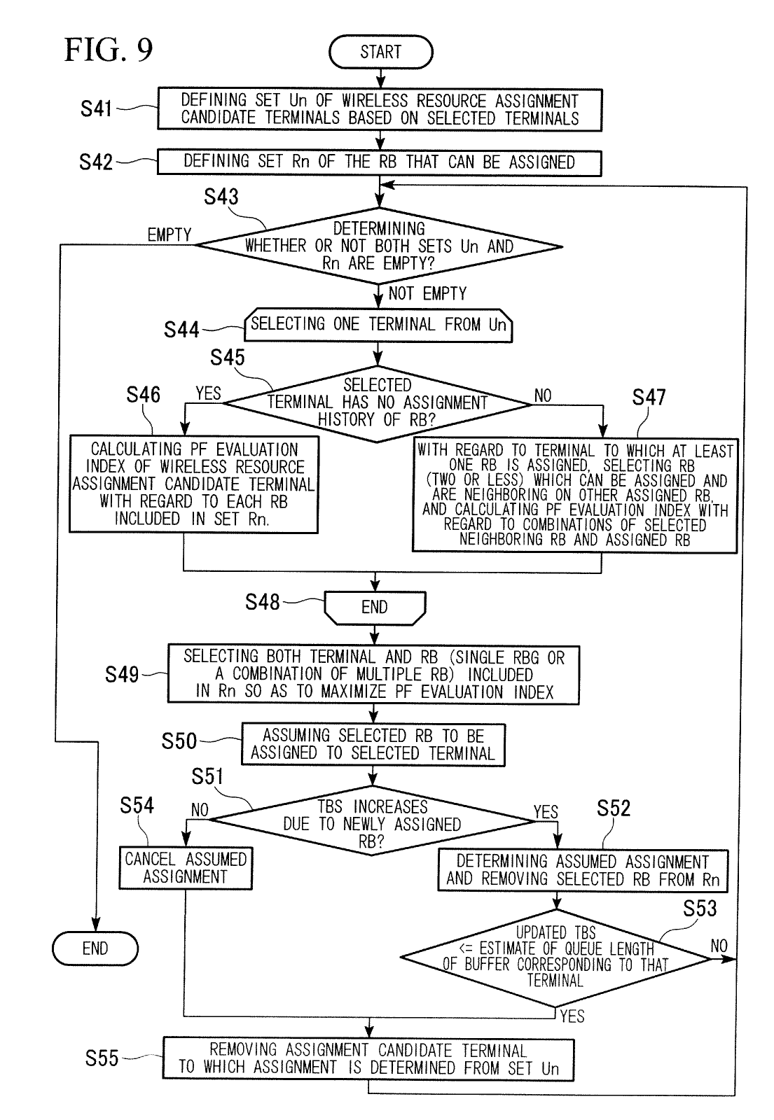

FIG. 9 is a flowchart showing details of Step 2 of FIG. 3 for Example 2. FIG. 9 shows an RB assignment operation of Step S2 conducted on one subframe. Hereinafter, in reference to FIG. 9, details of Step 2 of FIG. 3 for Example 2 are explained.

### (Step S41)

A set Un of the wireless resource assignment candidate terminals is defined based on all wireless resource assignment candidate terminals selected in Step S1

### (Step S42)

A set Rn of the RB that can be assigned is defined based on all RB that can be assigned.

### (Step S43)

A determination operation is conducted to determine whether or not the set Un which is a set of the wireless resource assignment candidate terminals is empty and whether or not the set Rn which is a set of the RB that can be assigned is empty. Base on such determination results, if both the sets Un and Rn are not empty, operation of Step S44 is conducted, and if at least one of the sets Un and Rn is not empty, operations shown in FIG. 9 are completed.

In Steps S44-S48, the PF evaluation index of all wireless resource assignment candidate terminals of the set Un is calculated respectively with regard to all RB of the set Rn that can be assigned.

### (Step S44)

One of the wireless resource assignment candidate terminals is selected from the set Un.

### (Step S45)

A determination operation is conducted to determine whether or not the RB is assigned to the wireless resource assignment candidate terminal selected in Step S44. Based on such a determination result, if no RB is assigned to the wireless resource assignment candidate terminal, operation of Step S46 is conducted, and if at least one RB is assigned to the wireless resource assignment candidate terminal, operation of Step S47 is conducted.

### (Step S46)

The PF evaluation index of the wireless resource assignment candidate terminals to which no RB is assigned yet is calculated respectively with regard to all RB of the set Rn that can be assigned.

### (Step S47)

With regard to the wireless resource assignment candidate terminal to which at least one RB is assigned, the RB (two or less) which can be assigned and which are neighboring on other RB that is already assigned are selected from the set Rn, and the PF evaluation index of that wireless resource assignment candidate terminals is calculated with regard to combinations of that selected RB which can be assigned and the RB which is already assigned (in other words, with regard to a pair of neighboring RB).

### (Step S48)

An operation of Step S49 is conducted when calculation of the PF evaluation indices is finished with regard to all wireless resource assignment candidate terminals of the set Un.

### (Step S49)

The maximum PF evaluation index is selected from the PF evaluation indices calculated in Steps S44-S48, and both the wireless resource assignment candidate terminal and RB (single RB or a combination of multiple RBG, hereinafter, assignment candidate RB) are selected corresponding to the selection result of the maximum PF evaluation index.

### (Step S50)

The wireless resource assignment candidate terminal and assignment candidate RB selected in Step S49 are stored as wireless resource assignment temporal information.

### (Step S51)

A determination operation is conducted to determine whether or not the maximum data size for transportation (TBS) of the wireless resource assignment candidate terminal selected in Step S49 is increased due to the assignment candidate RBG. Based on the determination result, an operation of Step S52 is conducted if TBS increases, and an operation of Step S54 is conducted if TBS does not increase.

### (Step S52)

If TBS of the wireless resource assignment candidate terminal increases due to the assignment candidate RB, the wireless resource assignment temporal information memorized in Step S50 is determined as wireless resource assignment information, and the assignment candidate RB is removed from the set Rn which is a set of RB that can be assigned.

### (Step S53)

A determination operation is conducted to determine whether or not “TBS (updated TBS) increased due to the assignment candidate RB”>=“data size stored in the data buffer directed to the wireless resource assignment candidate terminal (estimate of a queue length)” is satisfied. If such an equation is true, operation of Step S55 is conducted. On the other hand, if such an equation is not true, operation of Step S43 is conducted while the wireless resource assignment candidate terminal is still included in the set Un.

### (Step S54)

If TBS of the wireless resource assignment candidate terminal does not increase due to the assignment candidate RB, the wireless resource assignment temporal information memorized in Step S50 is cancelled.

### (Step S55)

When the wireless resource assignment temporal information is cancelled, or when the equation of Step S53 is true, the wireless resource assignment candidate terminal is removed from the set Un. After this, operation of Step S43 is conducted.

### [Step S3]

In Step S3, a determination operation is conducted to determine whether or not RB that can be assigned (un-assigned RB) remains after assigning the wireless resources in Step S2. As a result of such a determination, if the un-assigned RB still remains, operation of Step S4 is conducted, and if the un-assigned RB does not remain, operations of FIG. 3 are finished. However, if “the number of wireless resource assignment candidate terminals (N)=the maximum number of the terminals for assignment (M)” is satisfied, the operations shown in FIG. 3 are finished regardless of whether or not un-assigned RB remains. Therefore, only if un-assigned RB remains and “N<M”, operation of Step S4 is conducted.

### [Step S4]

In Step S4, to the terminals which issue the wireless resource assignment requests other than the terminals that are the wireless resource assignment candidate terminals selected in Step S1, the PF scheduler assigns the un-assigned RB so as to maximize the evaluation index of the physical layer. Here, RB can be assigned to “M-N” terminals at the most. Therefore, RBG is assigned to the terminals one-by-one.

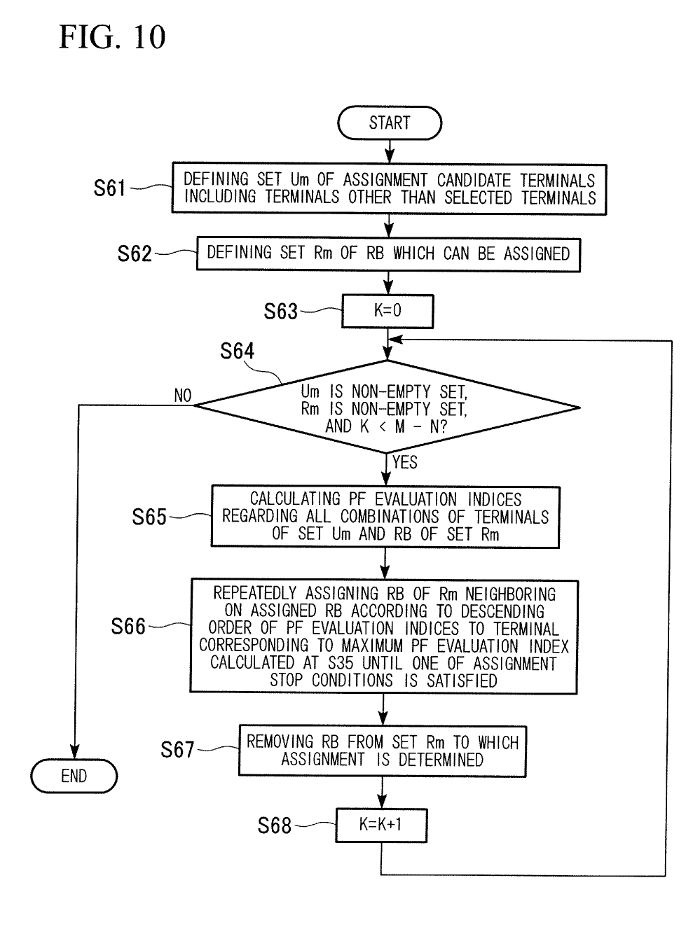

FIG. 10 is a flowchart showing details of Step 4 of FIG. 3 for Example 2. FIG. 10 shows an RB assignment operation of Step S4 conducted on one subframe. Hereinafter, in reference to FIG. 10, details of Step S4 of FIG. 3 for Example 2 are described.

### (Step S61)

A set Um of the wireless resource assignment candidate terminals is defined based on all terminals which issue the wireless resource assignment requests other than the wireless resource assignment candidate terminals selected in Step S1

### (Step S62)

A set Rm of the RB that are not assigned yet is defined based on all of the RB that are un-assigned.

### (Step S63)

The number of terminals K (number of assigned terminals) is initialized by setting “0” that indicates the number of terminals assigned to one RB to which currently no terminals are assigned.

### (Step S64)

It is determined whether or not “the set Um of the wireless resource assignment candidate terminals is not an empty set”, “the set Rm of un-assigned RB is not an empty set” and “K<‘M-N’” are satisfied. An operation of Step S65 is conducted if such a determination result is true, and operations of FIG. 10 are finished if such a determination result is not true.

### (Step S65)

Regarding all combinations of the wireless resource assignment candidate terminals of the set Um and the un-assigned RB of the set Rm, the PF evaluation indices are calculated.

### (Step S66)

The maximum PF evaluation index is selected from the PF evaluation indices calculated in Step S65, and both the wireless resource assignment candidate terminal and RB (single RB, hereinafter, assignment candidate RB) are selected corresponding to the selection result of the maximum PF evaluation index. After this, until at least one of following assignment stop conditions 1 and 2 is satisfied, the un-assigned RB neighboring on the assignment candidate RB is selected from the set Rm one-by-one in accordance with the PF evaluation indices of the un-assigned RB arranged in descending order and is added to the combination of the selected wireless resource assignment candidate terminal and assignment candidate RB, and in accordance with such an operation, the RB becomes a candidate RB for assigning to the wireless resource assignment candidate terminal.

Assignment stop condition 1: regarding the wireless resource assignment candidate terminal, the updated TBS which is updated by adding the un-assigned RB is larger than a data size (estimated length of a queue) stored in the data buffer of the wireless resource assignment candidate terminal. When the assignment condition 1 is satisfied, up to the currently added RB, the un-assigned RB that have been added are determined as the RB to be assigned to the wireless resource assignment candidate terminal, and an assignment operation of the un-assigned RB to the wireless resource assignment candidate terminal is finished.

Assignment stop condition 2: regarding the wireless resource assignment candidate terminal, the TBS updated by adding the un-assigned RB decreases compared to the TBS before the update. When the assignment condition 2 is satisfied, the currently added RB is cancelled, the un-assigned RB that have been added are determined as the RB to be assigned to the wireless resource assignment candidate terminal, and an assignment operation of the un-assigned RB to the wireless resource assignment candidate terminal is finished.

### (Step S67)

The wireless resource assignment candidate terminal to which assignment of the un-assigned RB is completed in Step S66 is removed from the set Um of the wireless resource assignment candidate terminals, and the corresponding assigned RB are removed from the set Rm of the un-assigned RB.

### (Step S68)

The number of assigned terminals K is incremented by 1. After this, an operation of Step S64 is conducted.

Explanations of Example 2 are finished.

In accordance with this Example, it is possible to have an advantage of surely reflecting the evaluation index of the application layer or the TCP layer to the assignment of the wireless resources and of reducing difficulty to have a desired Multi-user Diversity gain when using OFDMA or SC-FDMA.

As described above, the embodiments are explained in reference to the drawings. However, the constitution of the present invention is not limited by the embodiments, and it is possible to apply changes to the design of the embodiments so as not to exceed the scope of the present invention.

For example, the Examples 1 and 2 are applied to the LTE system as described above. However, this is not a limitation, and the present invention can be applied to other wireless communication systems.

What is claimed is:

1. A wireless resource assignment apparatus for assigning wireless resources to terminals when the terminals communicate with a base station in a wireless system, comprising:
a wireless resource assignment candidate terminal selection portion which, from the terminals that issue requests for assigning the wireless resources, selects a predetermined number of said terminals that are candidates to which the wireless resources are assigned in accordance with evaluation indices of at least one of an application layer and a TCP layer of said terminals arranged in descending order; and
a wireless resource assignment portion which assigns the wireless resources to the predetermined number of said selected terminals that are wireless resource assignment candidate terminals while maximizing the evaluation indices of a physical layer.

2. The wireless resource assignment apparatus according to claim 1, wherein
if un-assigned wireless resources still remain after assigning the wireless resources to the predetermined number of said selected wireless resource assignment candidate terminals, the wireless resource assignment portion assigns the un-assigned wireless resources to the terminals which issue the wireless resource assignment requests other than the wireless resource assignment candidate terminals selected by the wireless resource assignment candidate terminal selection portion while maximizing the evaluation indices of the physical layer.

3. The wireless resource assignment apparatus according to claim 1, further comprising
a TCP average throughput calculation portion which calculates a TCP instant throughput every when time the base station receives TCP-ACK from the terminals and calculates the TCP average throughput by using the TCP instant throughput, wherein
the wireless resource assignment candidate terminal selection portion uses the TCP average throughput as the evaluation indices of the TCP layer, and
the wireless resource assignment apparatus assigns the wireless resources applied to downlinks to the terminals.

4. The wireless resource assignment apparatus according to claim 1, further comprising
a TCP/IP packet counting portion which counts the number of TCP/IP packets that are received by the base station for a predetermined time and that are directed to the terminals, wherein
the wireless resource assignment candidate terminal selection portion uses the number of the TCP/IP packets as the evaluation indices of the TCP layer, and
the wireless resource assignment apparatus assigns the wireless resources applied to downlinks to the terminals.

5. The wireless resource assignment apparatus according to claim 1, further comprising
a TCP average throughput calculation portion which calculates a TCP instant throughput every when the base station transmits TCP-ACK the terminals and calculates the TCP average throughput by using the TCP instant throughput, wherein
the wireless resource assignment candidate terminal selection portion uses the TCP average throughput as the evaluation indices of the TCP layer, and
the wireless resource assignment apparatus assigns the wireless resources applied to uplinks to the terminals.

6. The wireless resource assignment apparatus according to claim 1, further comprising
an information collection portion which collects information of a TCP average throughput from the terminals that is calculated every time the terminals receive TCP-ACK, wherein
the wireless resource assignment candidate terminal selection portion uses the TCP average throughput as the evaluation indices of the TCP layer, and
the wireless resource assignment apparatus assigns the wireless resources applied to uplinks to the terminals.

7. The wireless resource assignment apparatus according to claim 1, further comprising
an information collection portion which collects information of a congestion window (cwnd) size from the terminals of the TCP layer, wherein
the wireless resource assignment candidate terminal selection portion uses the cwnd size as the evaluation indices of the TCP layer, and
the wireless resource assignment apparatus assigns the wireless resources applied to uplinks to the terminals.

8. The wireless resource assignment apparatus according to claim 1, further comprising
an information collection portion which collects information of a number of TCP/IP packets received by the terminals from the terminals, wherein
the wireless resource assignment candidate terminal selection portion uses the number of the TCP/IP packets as the evaluation indices of the TCP layer, and
the wireless resource assignment apparatus assigns the wireless resources applied to downlinks to the terminals.

9. The wireless resource assignment apparatus according to claim 1, further comprising:
an information collection portion which collects information of receiving time of TCP/IP packets received by the terminals from the terminals; and
a TCP/IP packet counting portion which counts a number of TCP/IP packets received by the terminals for a predetermined time based on the collected information, wherein
the wireless resource assignment candidate terminal selection portion uses the number of the TCP/IP packets as the evaluation indices of the TCP layer, and
the wireless resource assignment apparatus assigns the wireless resources applied to downlinks to the terminals.

10. A wireless communication system comprising the wireless resource assignment apparatus according to claim 1.

11. A wireless resource assignment method for assigning wireless resources to terminals that is used when the terminals communicate with a base station in a wireless system, comprising:
a first step of, from the terminals that issue requests for assigning the wireless resources, selecting a predetermined number of said terminals that are candidates to which the wireless resources are assigned in accordance with evaluation indices of at least one of an application layer and a TCP layer of said terminals arranged in descending order; and
a second step of assigning the wireless resources to the predetermined number of said selected terminals that are wireless resource assignment candidate terminals while maximizing the evaluation indices of a physical layer.

12. The wireless resource assignment method according to claim 11, further comprising
a third step of, if un-assigned wireless resources still remain after assigning the wireless resources to the predetermined number of said selected wireless resource assignment candidate terminals, assigning the un-assigned wireless resources to the terminals which issue the wireless resource assignment requests other than the wireless resource assignment candidate terminals selected by the first step while maximizing the evaluation indices of the physical layer.
